(19) United States
(12) Patent Application Publication
(10) Pub. No.: US 2021/0112310 A1
(43) Pub. Date: Apr. 15, 2021

(54) SCHEDULE MANAGEMENT METHOD FOR PLAYBACK DEVICE AND SCHEDULE MANAGEMENT SYSTEM

(71) Applicant: Acer Incorporated, New Taipei City (TW)

(72) Inventor: Chun-Hua Lee, New Taipei City (TW)

(73) Assignee: Acer Incorporated, New Taipei City (TW)

(21) Appl. No.: 17/064,597

(22) Filed: Oct. 6, 2020

(30) Foreign Application Priority Data
Oct. 9, 2019 (TW) 108136748

(51) Int. Cl. H04N 21/472; H04N 21/262; H04N 21/274

(52) U.S. Cl. CPC H04N 21/47217; H04N 21/274; H04N 21/2625; H04N 21/26258

(57) ABSTRACT

A schedule management method for a playback device and a schedule management system are provided. The method includes: providing a play list, where the play list records playing schedule information of a plurality of multimedia files; performing a multimedia file playing operation by the playback device according to the play list to play at least one of the multimedia files; detecting delay time information corresponding to the multimedia file playing operation; and automatically updating the play list according to the delay time information.

### CROSS-REFERENCE TO RELATED APPLICATION

This application claims the priority benefit of Taiwan patent application serial no. 108136748, filed on Oct. 9, 2019. The entirety of the above-mentioned patent application is hereby incorporated by reference herein and made a part of this specification.

### TECHNICAL FIELD

The disclosure relates to a schedule management technology and more particularly to a schedule management method for a playback device and a schedule management system.

### DESCRIPTION OF RELATED ART

As information transmission becomes more and more popular, many manufacturers are willing to set up electronic signage devices in public areas, such as shopping centers, office buildings, and so on, so as to broadcast multimedia advertisements provided by customers. However, the device performance of multiple electronic signage devices is often inconsistent. Different electronic signage devices may present different delay conditions corresponding to the same play list. In addition, the process of switching programs may cause a delay, and the delay may gradually accumulate during the process of continuously playing a plurality of multimedia files, which may cause some of the programs on the play list not to be played within a predetermined time range.

### SUMMARY

The disclosure provides a schedule management method for a playback apparatus and a schedule management system, which may dynamically adjust a play list according to a delay condition of the playback apparatus, thereby better solving the above problem.

An embodiment of the disclosure provides a schedule management method for a playback apparatus, and the method includes steps of: providing a play list, wherein the play list records playing schedule information of a plurality of multimedia files; performing a multimedia file playing operation by the playback device according to the play list to play at least one of the multimedia files; detecting delay time information corresponding to the multimedia file playing operation; automatically updating the play list according to the delay time information.

An embodiment of the disclosure further provides a schedule management system including a server device and a playback device. The server device is configured to provide a play list. The play list records playing schedule information of a plurality of multimedia files. The playback device is configured to perform a multimedia file playing operation according to the play list to play at least one of the multimedia files. The server device is further configured to detect delay time information corresponding to the multimedia file playing operation. The server device is further configured to automatically update the play list according to the delay time information.

Based on the above, after the play list recording the playing schedule information of the multimedia files is provided to the playback device, the playback device may perform the multimedia file playing operation according to the play list. After that, the delay time information corresponding to the multimedia file playing operation may be detected. The play list may be automatically updated according to the delay time information. In other words, the play list provided to the playback device may be personalized through the playing history of the playback device (i.e., the delay time information) according to one or more embodiments of the disclosure, thereby effectively solving the above problem.

In order to make the aforementioned advantages of the disclosure comprehensible, embodiments accompanied with figures are described in detail below.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles described herein.

FIG. 1 and FIG. 2 are schematic diagrams of a schedule management system according to an embodiment of the disclosure.

FIG. 3A to FIG. 3C are schematic diagrams of a play list and feedback information according to an embodiment of the disclosure.

FIG. 4A to FIG. 4C are schematic diagrams of a play list and feedback information according to an embodiment of the disclosure.

FIG. 5 is a schematic diagram of buffer time corresponding to different rules according to an embodiment of the disclosure.

FIG. 6 is a flowchart of a schedule management method for a playback device according to an embodiment of the disclosure.

### DESCRIPTION OF THE EMBODIMENTS

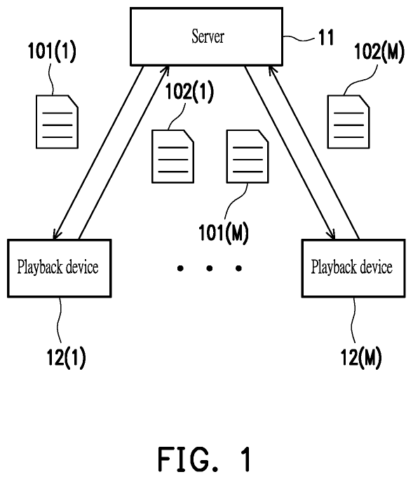

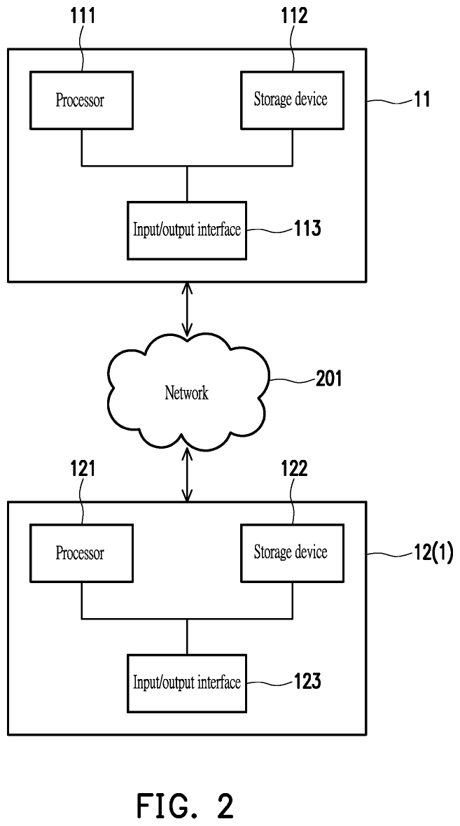

FIG. 1 and FIG. 2 are schematic diagrams of a schedule management system according to an embodiment of the disclosure. With reference to FIG. 1, the system 10 (also known as the schedule management system) includes a server 11 (also referred to as a server device) and playback devices 12(1)-12(M) (also referred to as terminal devices). The server 11 may include a computer host (also referred to as a server host) having information processing and communication functions, such as a smart phone, a notebook computer, a desktop computer, and/or an industrial computer. The number of computer hosts included in the server 11 is not limited in the disclosure. Each of the playback devices 12(1)-12(M) may be a multimedia file player capable of performing a multimedia file playback function and a communication function, such as a smart phone, a notebook computer, a desktop computer, a digital signage (such as a Kiosk), and so on. The number of playback devices 12(1)-12(M) is not limited in the disclosure.

The server 11 may transmit play lists 101(1)-101(M) to the playback devices 12(1)-12(M). For instance, the play list 101(i) (i is within a range from 1 to M) is configured to record playing schedule information of a plurality of multimedia files, and the playback device 12(i) may play the multimedia files in a predetermined time range according to the playing schedule information of the play list 101(i). In an embodiment, the predetermined time range refers to one day (i.e., 24 hours). However, in another embodiment, the predetermined time range may be longer (e.g., 3 days) or shorter (e.g., 12 hours). The type of the multimedia files may include an image file and/or a video file. Each of the playback devices 12(1)-12(M) may play the multimedia files via video, sound, or a combination of video and sound.

According to the actual playing condition, the playback devices 12(1)-12(M) may transmit feedback information 102(1)-102(M) back to the server 11. For instance, the feedback information 102(i) may be used to record actual time of playing at least one multimedia file played by the playback device 12(i) (e.g., start time and/or ending time of playing the multimedia file). The feedback information 102(1)-102(M) may respectively reflect the software/hardware performance of the playback devices 12(1)-12(M). For instance, assuming that the playback device 12(i) have poor capabilities of decoding the multimedia files, the start time of playing a certain multimedia file in the feedback information 102(i) may be later than the start time of playing the corresponding multimedia file in the play list 101(i) (indicating that playback delay has occurred). In response to the difference in the software/hardware performance among the playback devices 12(1)-12(M), even if the playing schedule information recorded in the play lists 101(1)-101(M) is identical, the feedback information 102(1)-102(M) may also be different. The server 11 may adjust the play lists 101(1) to 101(M) that are subsequently provided to the playback devices 12(1)-12(M) according to the feedback information 102(1)-102(M). In the following embodiments, the interaction between the server 11 and the playback device 12(1) is described, while the relevant details of operations may be analogized to the other playback devices.

With reference to FIG. 2, the server 11 may include a processor 111, a storage device 112, and an input/output interface 113. The processor 111 may include a central processing unit, a graphics processor, an embedded controller, or any other programmable general-purpose or specific-purpose microprocessor, digital signal processor, programmable controller, application specific integrated circuit (ASIC), programmable logic device, any other similar device, or a combination of these devices. The processor 111 is responsible for the overall or partial operation of the server 11.

The storage device 112 is coupled to the processor 111 and configured to store data. For instance, the storage device 112 may include a volatile storage medium and a non-volatile storage medium. Here, the volatile storage medium may be a random access memory, and the non-volatile storage medium may be a read only memory, a solid state drive (SSD), or a conventional hard disk.

The input/output interface 113 is coupled to the processor 111. The input/output interface 113 is configured to receive and/or output signals. For instance, the input/output interface 113 may include a screen, a touch screen, a touch pad, a mouse, a keyboard, a physical button, a speaker, and/or a microphone, and the type of the input/output interface 113 is not limited thereto.

The playback device 12(1) includes a processor 121, a storage device 122, and an input/output interface 123. The processor 121 may include a central processing unit, a graphics processor, an embedded controller, or any other programmable general-purpose or specific-purpose microprocessor, digital signal processor, programmable controller, ASIC, programmable logic device, any other similar device, or a combination of these devices. The processor 121 is responsible for the overall or partial operation of the playback device 12(1).

The storage device 122 is coupled to the processor 121 and configured to store data. For instance, the storage device 122 may include a volatile storage medium and a non-volatile storage medium. Here, the volatile storage medium may be a random access memory, and the non-volatile storage medium may be a read only memory, a solid state drive (SSD), or a conventional hard disk.

The input/output interface 123 is coupled to the processor 121. The input/output interface 123 is configured to receive and/or output signals. For instance, the input/output interface 123 may include a screen, a touch screen, a touch pad, a mouse, a keyboard, a physical button, a speaker, and/or a microphone, and the type of the input/output interface 123 is not limited thereto. The software/hardware architecture of the playback device 12(1) may be the same as or similar to the software/hardware architecture of any of the playback devices 12(2)-12(M), and details are not described hereinafter.

In an embodiment, the input/output interface 113 includes a wired communication interface and/or a wireless communication interface, and the input/output interface 123 includes a wired communication interface and/or a wireless communication interface. The input/output interface 113 may communicate with the input/output interface 123 via network 201. For instance, the input/output interfaces 113 and 123 may support at least one of an Ethernet communication technology, Wireless Fidelity (Wi-Fi), a third generation (3G) wireless communication technology, Long Term Evolution (LTE), a fourth generation (4G) wireless communication technology, a fifth generation (5G) wireless communication technology, or a similar wired/wireless communication technology. The network 201 may include Internet or a regional network.

In an embodiment, the processor 111 may generate the play list 101(1) according to requirements of manufacturers or customers and transmit the play list 101(1) to the playback device 12(1) via the input/output interface 113. The play list 101(1) may record the playing schedule information of advertisements or other multimedia files to be played as per requests of the manufacturers or the customers. The processor 121 may receive the play list 101(1) via the input/output interface 123 and instruct the input/output interface 123 to play the corresponding multimedia files according to the play list 101(1) within the predetermined time range. For instance, the input/output interface 123 may play one or more multimedia files via a screen and/or a speaker. In an embodiment, the operation of playing one or more multimedia files via the input/output interface 123 is also referred to as a multimedia file playing operation.

In an embodiment, the processor 121 may record the actual time of playing each of the multimedia files (e.g., the start time and/or ending time of playing each multimedia file). The processor 121 may generate the feedback information 102(1) according to the recorded actual play time and transmit the feedback information 102(1) to the server 11 via the input/output interface 123.

In an embodiment, the processor 111 may detect the delay time information corresponding to the multimedia file playing operation performed by the playback device 12(1) according to the feedback information 102(1) from the playback device 12(1). For instance, the processor 111 may obtain the delay time information according to the playing schedule information of the multimedia files recorded in the play list 101 (1) and the actual time of playing the multimedia files recorded in the feedback information 102 (1). For instance, the delay time information may reflect the difference between the playing schedule information of a certain multimedia file and the actual time of playing the multimedia file. The processor 111 may automatically update the play list 101(1) subsequently provided to the playback device 12(1) based on the delay time information. For instance, assuming that the feedback information 102(1) reflects that the performance of processing video files by the playback device 12(1) is not satisfying, the processor 111 may delay the start time of playing a certain video file in the play list 101(1). Thereby, when the multimedia file playing operation is performed next time according to the play list 101(1), the playback device 12(1) may play the corresponding multimedia files based on the scheduled play time as far as possible.

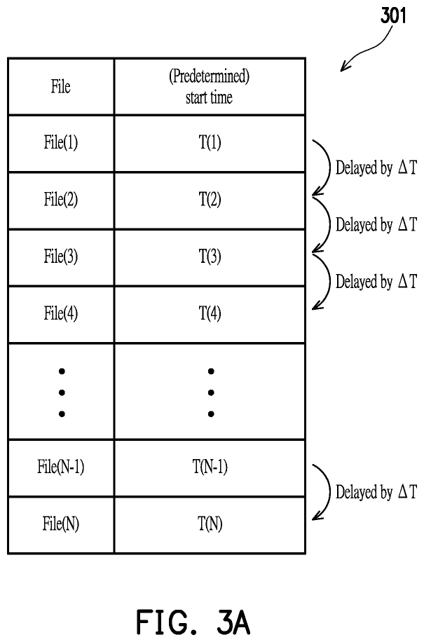

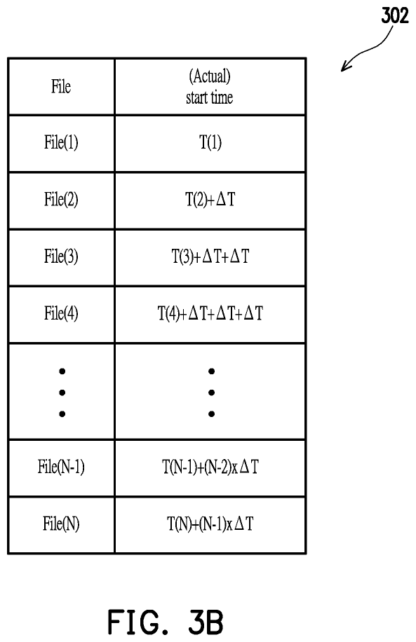

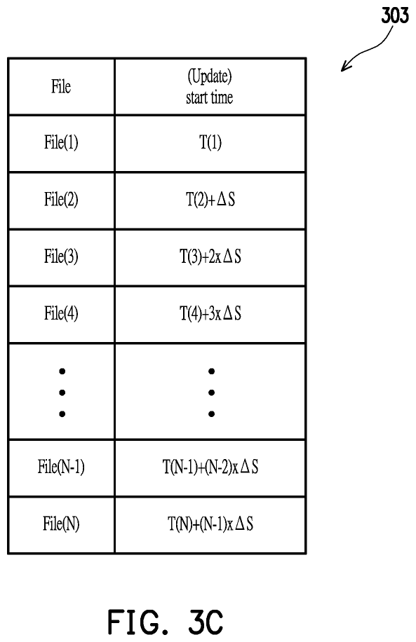

FIG. 3A to FIG. 3C are schematic diagrams of a play list and feedback information according to an embodiment of the disclosure. As shown in FIG. 3A, assuming that the play list 301 records the playing schedule information of the multimedia files File(1)-File(N), the playing schedule information may reflect that the start time of playing the multimedia files File(1)-File(N) is T(1)-T(N), respectively. For instance, if it is assumed that each multimedia file is a video file and each multimedia file has a file length of 30 seconds, then T(1) may be 00:00:00, T(2) may be 00:00:30, and T(N) may be 23:59:30, which should however not be construed as a limitation in the disclosure. In an embodiment, the multimedia files of different lengths and/or different types may also be recorded in the play list 301. The playback device (e.g., the playback device 12(1) depicted in FIG. 1) may sequentially play the multimedia files File(1)-File(N) according to the play list 301.

In this embodiment, note that it is assumed that the delay occurs every time of switching to play the next multimedia file (e.g., delayed by time ΔT). Therefore, feedback information 302 of the reflected time ΔT (also known as the delay time) may be generated as shown in FIG. 3B. For instance, based on the feedback information 302, the multimedia file File(1) starts to be played at a predetermined time T(1). However, the delay occurs at the time of switching to play the multimedia file File(2), thus causing the start time of playing the multimedia file File(2) to be delayed from the predetermined time T(2) to T(2)+ΔT. Similarly, the delay occurs at the time of switching to play the multimedia file File(3), thus causing the start time of playing the multimedia file File(3) to be delayed from the predetermined time T(3) to T(3)+ΔT+ΔT. As the delay time accumulates, the actual start time of playing the multimedia file File(N) is also delayed from time T(N) to T(N)+(N−1)×ΔT. The predetermined time range of one day (i.e., 24 hours) is taken as an example, and it is assumed that the multimedia file File(N) starts to be played at the schedule time 23:59:30 (i.e., T(N)). However, due to the delay of playing the multimedia files File(2)-File(N−1), the multimedia file File(N) (or File(N−1)) may not be played by 24:00:00 of the day (Because the scheduled time of playing the multimedia files on the next day starts after 24:00:00). Under said circumstances, the manufacturers or customers may cancel a partial payment or even cancel the remaining orders because the advertisement was not played accidentally.

In this embodiment, the feedback information 302 may be provided to a server (e.g., the server 11 shown in FIG. 1) to update the play list 301 shown in FIG. 3A. For instance, based on the feedback information 302, the play list 301 may be updated to the play list 303 as shown in FIG. 3C. In the play list 303, the start time of playing the multimedia files File(2)-File(N) is updated (i.e., delayed). For instance, the start time of playing the multimedia file File(2) may be delayed to T(2)+ΔS, the start time of playing the multimedia file File(3) may be delayed to T(3)+2×ΔS, and the start time of playing the multimedia file File(N) may be delayed to T(N)+(N−1)×ΔS.

In the present embodiment, time ΔS is determined according to the time ΔT (i.e., the delay time). For instance, the time ΔS may be equal to the time ΔT, so as to match the delay time information reflected by the feedback information 302. The play list 303 may be re-provided to the playback device 12(1). The playback device 12(1) may play the multimedia files File(1)-File(N) in the next predetermined time range (e.g., the next day) according to the play list 303. In particular, since the delay time information corresponding to the playback device 12(1) performing the multimedia file playing operation in the play list 303 has been taken into account, the playback device 12(1) may accurately play the corresponding multimedia files at the predetermined time point in the new play list 303.

In an embodiment, when the play list is updated, if the new time of playing a certain multimedia file (e.g., the multimedia file File(N)) schedule to be played later exceeds the predetermined time range, then the multimedia file (e.g., the multimedia file File(N)) may also be removed from the play list 303. The removed multimedia file File(N) may be played by another playback device or scheduled to be played at another time point. Compared with the play list 301, although the play list 303 may only include fewer multimedia files, the predetermined time of playing each multimedia file in the play list 303 may be more accurate, thereby better resolving the issue of not being able to completely play all of the multimedia files within the predetermined time range.

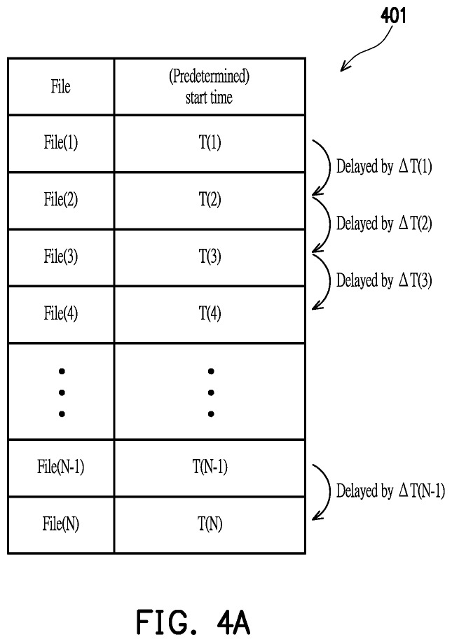

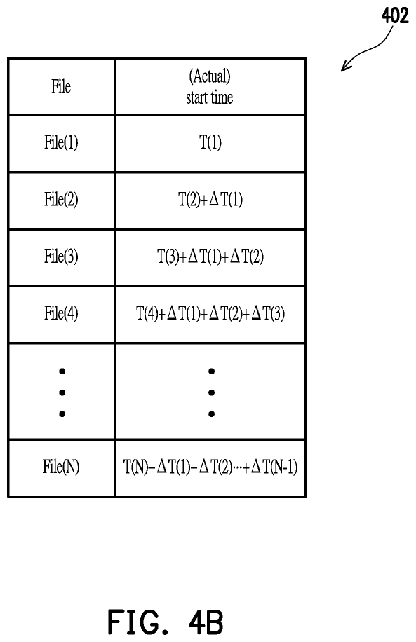

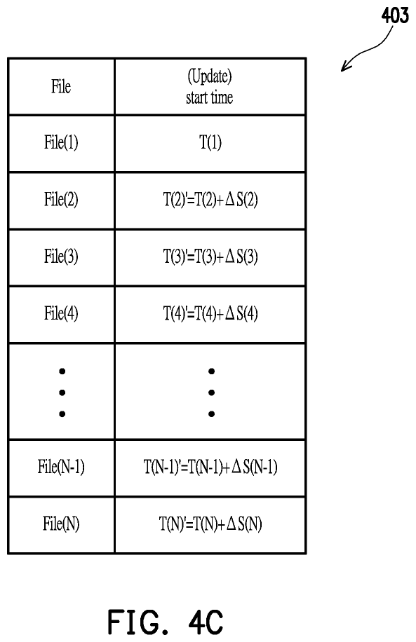

FIG. 4A to FIG. 4C are schematic diagrams of a play list and feedback information according to an embodiment of the disclosure. As shown in FIG. 4A, assuming that the play list 401 records the playing schedule information of the multimedia files File(1)-File(N), the playing schedule information may reflect that the predetermined start time of playing the multimedia files File(1)-File(N) is T(1)-T(N), respectively. The playback device (e.g., the playback device 12(1) shown in FIG. 1) may sequentially play the multimedia files File(1)-File(N) according to the play list 401.

In this embodiment, note that it is assumed that switching from playing the multimedia file File(1) to playing the multimedia file File(2) is delayed by the time ΔT(1), switching from playing the multimedia file File(2) to playing the multimedia file File(3) is delayed by the time ΔT(2); switching from playing the multimedia file File(3) to playing the multimedia file File(4) is delayed by the time ΔT(3); switching from playing the multimedia file File(N−1) to playing the multimedia file File(N) is delayed by the time ΔT(N−1). Every two of the time ΔT(1)-ΔT(N−1) may be the same or different.

According to the actual time of playing the multimedia files File(1)-File(N), the feedback information 402 may be generated as shown in FIG. 4B. For instance, based on the feedback information 402, the multimedia file File(1) starts to be played at the predetermined time T(1). However, the delay occurs at the time of switching to play the multimedia file File(2), thus causing the start time of playing the multimedia file File(2) to be delayed from the predetermined time T(2) to T(2)+ΔT(1). Similarly, the delay also occurs at the time of switching to play the multimedia file File(3), thus causing the start time of playing the multimedia file File(3) to be delayed from the predetermined time T(3) to T(3)+ΔT(1)+ΔT(2). As the delay time accumulates, the actual start time of playing the multimedia file File(N) is also delayed to T(N)+ΔT(1)+ΔT(2)+ . . . +ΔT(N−1).

In this embodiment, the feedback information 402 may be provided to a server (such as the server 11 shown in FIG. 1) to update the play list 401 shown in FIG. 4A. For instance, based on the feedback information 402, the play list 401 may be updated to the play list 403 as shown in FIG. 4C. In the play list 403, the start time of playing the multimedia files File(2)-File(N) is updated (i.e., delayed). For instance, the start time of playing the multimedia file File(2) may be delayed to T(2)′(T(2)′=T(2)+ΔS(2)), the start time of playing multimedia file File(3) may be delayed to T(3)′(T(3)′=T(3)+ΔS(3)), and the start time of playing the multimedia file File(N) may be delayed to T(N)′(T(N)′=T(N)+ΔS(N)).

It should be noted that in the present embodiment, time ΔS(2) is determined according to the time ΔT(1), time ΔS(3) is determined according to the sum of the time ΔT(1) and the time ΔT(2), time ΔS(4) is determined according to the sum of the time ΔT(1), the time ΔT(2), and the time ΔT(3), and time ΔS(N) is determined according to the sum of the time ΔT(1)-the time ΔT(N−1). For instance, the time ΔS(2) may be equal to the time ΔT(1), the time ΔS(3) may be equal to the sum of the time ΔT(1) and the time ΔT(2), the time ΔS(4) may be equal to the sum of the time ΔT(1), the time ΔT(2), and the time ΔT(3), and the time ΔS(N) may be equal to the sum of the time ΔT(1)-the time ΔT(N−1). The play list 403 may be re-provided to the playback device 12(1). The playback device 12(1) may replay the multimedia files File(1)-File(N) in the next predetermined time range (e.g., the next day) according to the play list 403. Thereby, the playback device 12(1) may accurately play the corresponding multimedia files at the predetermined time point in the play list 403. In an embodiment, at least one multimedia file (e.g., the multimedia file File(N)) in the play list 403 may also be removed to control the total time of playing the multimedia files to be within a predetermined time range.

In an embodiment, the delay time (e.g., the time ΔT or the time ΔT(1)-the time ΔT(N−1)) is also referred to as buffer time. In the delay time information, the processor 111 of the server 11 may calculate the corresponding buffer time from playing a certain type (also called a first type) of the plurality of multimedia files to playing another type (also called a second type) of the plurality of multimedia files, and the processor 111 may then update the play list according to the buffer time. In an embodiment, for instance, the first type of multimedia files and the second type of multimedia files may respectively refer to one of a video file and an image file.

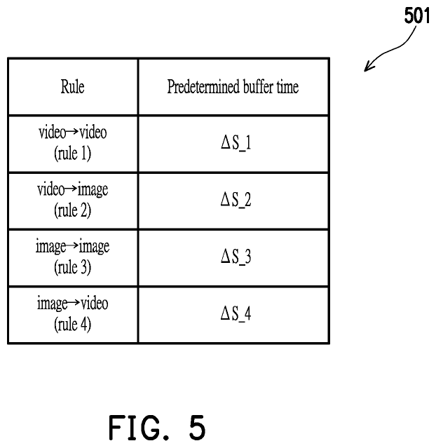

FIG. 5 is a schematic diagram of buffer time corresponding to different rules according to an embodiment of the disclosure. With reference to FIG. 5, based on the collected feedback information, the server (e.g., the processor 111 shown in FIG. 2) may create table information 501. The table information 501 record the (predetermined) buffer time ΔS_1-ΔS_4 corresponding to rules 1-4. The rule 1 means switching from playing a movie to playing a movie; the rule 2 means switching from playing a movie to playing an image; the rule 3 refers to switching from playing an image to playing an image; the rule 4 refers to switching from playing an image to playing a movie. The buffer time ΔS_1 represents the (average) buffer time required by a playback device (such as the playback device 12(1) shown in FIG. 1) for switching from playing a movie to playing a movie. The buffer time ΔS_2 represents the (average) buffer time required by the playback device for switching from playing a movie to playing an image. The buffer time ΔS_3 indicates the (average) buffer time required by the playback device for switching from playing an image to playing an image. The buffer time ΔS_4 indicates the (average) buffer time required by the playback device for switching from playing an image to playing a movie.

In an embodiment shown in FIG. 2, the processor 111 may update the buffer time ΔS_1-ΔS_4 based on the feedback information obtained from the playback device 12(1) at least once. Thereafter, the processor 111 may update the play list for the playback device 12(1) based on the table information 501. As exemplarily shown in FIG. 4A-FIG. 4C, it is assumed that the multimedia file File(1) is a video file and the multimedia file File(2) is an image file, and the processor 111 may determine the time ΔS(2) in FIG. 4C according to the buffer time corresponding to the rule 2 in the table information 501. For instance, the processor 111 may determine that the time ΔS(2) is equal to the buffer time ΔS_2. Alternatively, it is assumed that the multimedia file File(2) is an image file and the multimedia file File(3) is a video file, and the processor 111 may determine the time ΔS(3) in FIG. 4C according to the buffer time ΔS_4 corresponding to the rule 4 in the table information 501. For instance, the processor 111 may determine that the time ΔS(3) is equal to the buffer time ΔS_4. In an embodiment, the buffer time ΔS_1-ΔS_4 may be, for instance, 0.1 second, 0.5 second, 0 second (no delay), and 0.1 second.

In an embodiment, the buffer time corresponding to the switching operations between more types of multimedia files may also be obtained and should not be limited to the above-mentioned rules 1-4. For instance, in an embodiment, switching from playing the content of a certain online web page to playing a video file may be regarded as a rule 5, and the buffer time ΔS_5 corresponding to the rule 5 may be determined and added to the table information 501 shown in FIG. 5.

In an embodiment shown in FIG. 1 and FIG. 2, the processor 111 may correspondingly update the play list 101(1) after receiving the feedback information 102(1) from the playback device 12(1) each time. However, in another embodiment, the processor 111 updates the play list 101(1) only when certain conditions are met to reduce the update frequency of the play list 101(1) and/or to save computing resources of the server 11. For instance, in an embodiment, the processor 111 may determine, according to the feedback information 102(1), whether the total delay time (i.e., accumulated delay time) generated by the playback device 12(1) playing at least one multimedia file according to the play list 101(1) reaches a default value. If the total delay time reaches the default value, the processor 111 may update the play list 101(1) according to the feedback information 102(1) in response to the determination result. On the contrary, if the total delay time does not reach the default value, the processor 111 may not update the play list 101(1). For instance, in an embodiment, the default value may be 100 seconds. If it is assumed that the received feedback information 102(1) reflects that the actual time of playing a certain multimedia file is slower than the predetermined play time by 400 seconds, the processor 111 may update the play list 101 in response to the situation. On the other hand, if the received feedback information 102(1) is reflected in the predetermined time range, the actual time of playing the last played multimedia file is slower than the predetermined play time by 20 seconds, the processor 111 may temporarily not update the play list 101(1).

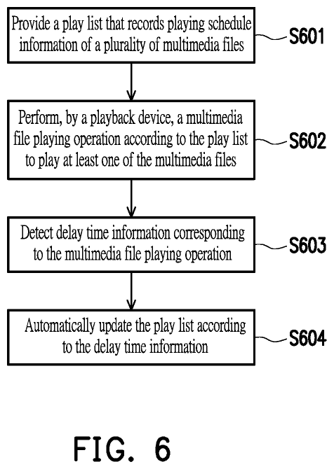

FIG. 6 is a flowchart of a schedule management method for a playback device according to an embodiment of the disclosure. As shown in FIG. 6, in step S601, a play list is provided. The play list records playing schedule information of a plurality of multimedia files. In step S602, a multimedia file playing operation is performed by the playback device according to the play list to play at least one of the multimedia files. In step S603, delay time information corresponding to the multimedia file playing operation is detected. In step S604, the play list is automatically updated according to the delay time information.

However, the steps shown in FIG. 6 have been described in detail above and will not be further explained hereinafter. Note that the steps in FIG. 6 may be implemented in form of codes or circuits, which should not be construed as a limitation in the disclosure. In addition, the method shown in FIG. 6 may be applied according to one or several embodiments described above, and the disclosure is not limited thereto.

To sum up, after the play list recording the playing schedule information of the multimedia files is provided to the playback device, the playback device may perform the multimedia file playing operation according to the play list. After that, the delay time information corresponding to the multimedia file playing operation may be detected. The play list may be automatically updated according to the delay time information. In other words, the play list provided to the playback device may be personalized by collecting the playing history of the playback device (i.e., the delay time information); thereby, the conventional problem that the playback delay of the terminal device cannot be easily controlled can be effectively resolved.

Although the disclosure has been disclosed in the above embodiments, it is not intended to limit the disclosure, and any one of ordinary skill in the art will be able to make some modifications and refinements without departing from the spirit and scope of the disclosure. The scope of the disclosure is defined by the scope of the appended claims.

What is claimed is:

1. A schedule management method for a playback device, comprising:
providing a play list, wherein the play list records playing schedule information of a plurality of multimedia files;
performing, by the playback device, a multimedia file playing operation according to the play list to play at least one of the plurality of multimedia files;
detecting delay time information corresponding to the multimedia file playing operation; and
automatically updating the play list according to the delay time information.

2. The schedule management method according to claim 1, wherein the step of detecting the delay time information corresponding to the multimedia file playing operation comprises:
obtaining actual play time of the at least one of the plurality of multimedia files; and
obtaining the delay time information according to the playing schedule information and the actual play time.

3. The schedule management method according to claim 1, wherein the step of automatically updating the play list according to the delay time information comprises:
determining whether total delay time generated by playing the at least one of the plurality of multimedia files reaches a default value; and
automatically updating the play list according to the delay time information in response to the total delay time reaching the default value.

4. The schedule management method according to claim 1, wherein the step of automatically updating the play list according to the delay time information comprises:
in the delay time information, calculating a corresponding buffer time from playing a first type of the plurality of multimedia files to playing a second type of the plurality of multimedia files; and
updating the play list according to the buffer time.

5. The schedule management method according to claim 1, wherein the step of automatically updating the play list according to the delay time information comprises:
delaying start time of playing a first multimedia file of the plurality of multiple multimedia files.

6. A schedule management system, comprising:
a server device configured to provide a play list, wherein the play list records playing schedule information of a plurality of multimedia files; and
a playback device configured to perform a multimedia file playing operation according to the play list to play at least one of the plurality of multimedia files,
wherein the server device is further configured to detect delay time information corresponding to the multimedia file playing operation, and
the server device is further configured to automatically update the play list according to the delay time information.

7. The schedule management system according to claim 6, wherein the detection of the the delay time information corresponding to the multimedia file playing operation by the server device comprises:
obtaining actual play time of the at least one of the plurality of multimedia files; and
obtaining the delay time information according to the playing schedule information and the actual play time.

8. The schedule management system according to claim 6, wherein the automatic update of the play list according to the delay time information by the server device comprises:
determining whether total delay time generated by playing the at least one of the plurality of multimedia files reaches a default value; and
automatically updating the play list according to the delay time information in response to the total delay time reaching the default value.

9. The schedule management system according to claim 6, wherein the automatic update of the play list according to the delay time information by the server device comprises:
in the delay time information, calculating a corresponding buffer time from playing a first type of the plurality of multimedia files to playing a second type of the plurality of multimedia files; and
updating the play list according to the buffer time

10. The schedule management system according to claim 6, wherein the automatic update of the play list according to the delay time information by the server device comprises:
delaying start time of playing a first multimedia file of the plurality of multiple multimedia files.
